(19) United States
(12) Patent Application Publication
(10) Pub. No.: US 2019/0134851 A1
(43) Pub. Date: May 9, 2019

(54) ANGLED CONCRETE SAW AND ANGLED CONCRETE SAW KIT ALONG WITH A METHOD OF USING THE SAME

(71) Applicant: Diamond Products, Limited, Elyria, OH (US)

(72) Inventors: Timothy Obrzut, Middleburg Heights, OH (US); Miroslav Pavlovic, Broadview Heights, OH (US); Daniel Griffin, Lorain, OH (US)

(21) Appl. No.: 16/181,916

(22) Filed: Nov. 6, 2018

Related U.S. Application Data
(60) Provisional application No. 62/583,068, filed on Nov. 8, 2017.

(51) Int. Cl. B28D 1/04

(52) U.S. Cl. CPC B28D 1/045

(57) ABSTRACT

A concrete saw configured to cut an underlying surface at an angle including a concrete saw having a saw frame, a saw blade, a motor to drive the saw blade and a platform structure to support the saw frame and allow movement of the concrete saw on an underlying surface, the platform structure including an angled support structure for supporting the saw frame relative to the platform structure at a platform angle, and a method of using the concrete saw to reduce falling concrete slabs or debris.

This application claims priority to provisional patent application Ser. No. 62/583,068 filed on Nov. 8, 2017, which is incorporated by reference herein.

### FIELD OF INVENTION

The present invention relates to saws for cutting concrete. More particularly, the present invention relates to a concrete saw that can cut on an angle and kits that can modify existing concrete saws to cut on an angle. Moreover, the present invention relates to methods of using an angled concrete saw.

### INCORPORATION BY REFERENCE

U.S. Pat. No. 7,117,864 to Marques et al. discloses a mobile road or floor saw and is incorporated by reference for showing the same. U.S. Pat. No. 7,434,889 to Moller et al discloses a self-propelled concrete saw and is incorporated by reference for showing the same. U.S. Pat. No. 8,360,045 to Marsic et al discloses a concrete saw and is incorporated by reference for showing the same. Published patent application No. US 2012/0068525 to Moller discloses a concrete saw having multiple motors and is incorporated by reference for showing the same. U.S. Pat. No. 8,342,610 to Marsic et al. discloses a green concrete saw and is incorporated by reference for showing the same. U.S. Pat. No. 8,931,471 to Ruffner et al. discloses a hybrid concrete saw and is incorporated by reference for showing the same. Published patent application No. US 2014/0102432 to Edwards discloses a cooling system for a concrete saw and is incorporated by reference for showing the same. 2015/0202796 to Ruffner discloses a cooling system for a concrete saw and is incorporated by reference for showing the same. U.S. Pat. No. 7,942,142 to Gobright, IV discloses a battery powered concrete saw and is incorporated by reference for showing the same. U.S. Pat. No. 8,347,872 to Gobright, IV also discloses a battery powered concrete saw and is also incorporated by reference for showing the same. U.S. Pat. No. 6,318,353 to Edwards et al. discloses a concrete saw with multispeed drive and is incorporated by reference for showing the same. U.S. Pat. No. 5,724,956 to Ketterhagen, IV discloses a riding saw for cutting concrete and is incorporated by reference for showing the same. U.S. Pat. No. 6,470,874 to Mertes discloses a high product, riding, concrete saw and is incorporated by reference for showing the same. U.S. Pat. No. 7,117,864 to Marques et al. discloses a mobile road or floor saw and is incorporated by reference for showing the same. U.S. Pat. No. 7,434,889 to Moller et al discloses a self-propelled concrete saw and is incorporated by reference for showing the same. U.S. Pat. No. 8,360,045 to Marsic et al discloses a concrete saw and is incorporated by reference for showing the same. Published patent application No. US 2012/0068525 to Moller discloses a concrete saw having multiple motors and is incorporated by reference for showing the same.

### BACKGROUND OF THE INVENTION

Concrete saws are used in a variety of applications including, but not limited to cutting and removing concrete from road surfaces and bridges. In order to safely cut and remove concrete from elevated roadways and/or bridges, it is important to prevent concrete and/or debris from falling from the elevated structures to the areas below the elevated structures.

Many methods have been used in the past to help prevent falling debris and/or cut concrete slabs from these elevated structures. These methods include the use of debris shield that are constructed at the jobsite. However, these prior methods and systems can be time consuming and costly to implement. Therefore, there remains a need in the industry to improve the cutting equipment and/or the method of using the cutting equipment to further improve both safety and efficiency for these concrete removal operations.

With reference to the documents incorporated by reference into this application, a concrete saw includes a cutting blade driven by one or more engines and/or motors connected to a saw frame. In some concrete saws, the motor is axially aligned, meaning that the motor shaft rotates on an axis that is parallel to the axis of rotation of the blade shaft. Power can be transferred from the motor shaft to the blade shaft using a wide range of systems including, but not limited to gears, transmission, shafts, V-belts and sheaves. The speed at which the blade shaft rotates can be adjusted by changing the size of the V-belts and sheaves, by changing the gears ratios in the transmission or the like. Other concrete saws include motor(s) or engine(s) that are aligned longitudinally, meaning that the motor shaft rotates about an axis that is perpendicular to the axis of rotation of the blade shaft. Different types of gears, transmissions and/or systems can be used to transfer power from the motor shaft to a transverse drive shaft, which is oriented such that the drive shaft rotates about an axis that is parallel to the axis of rotation of the blade shaft. The motor(s) or engine(s) and the saw blade are all supported by the concrete saw frame and can be fixed relative to the frame. The concrete saw can further include wheels to allow the saw to be moved into position and to allow movement during use. The wheels can include one or more driven wheels to propel the concrete saw again during movement and/or use. Typically, the wheels include a front wheel set and a rear wheel set that also can be secured relative to the frame.

In addition, concrete saws include a blade height adjustment system that can change and/or adjust a blade cutting depth. This can include hydraulically operated or assisted lifting or lowering assemblies or systems that can raise and lower the blade cutting depth. However, it is important that the adjustment system for the blade cutting depth move the blade perpendicular to the saw/frame rotation axis so that the cutting blade can be plunged into the concrete to be cut and be pulled out of the kerf cut by the concrete saw without binding. Existing concrete saws typically handle blade depth adjustment by including a lift system that can be joined to the front wheels wherein the front wheels move relative to the saw frame to raise the entire frame and thus the engine and the saw blade.

Moreover, there are both walk-behind concrete saws and ride on concrete saws. The walk behind saws include a pair of handles, that can be adjustable handles, that extend from the rear of the saw. The handles can be pivotable about a mounting assembly such that the outwardly extending handle ends can be pivoted upwards to compensate for blade height adjustment. The handle configuration is often preferred by operators when the front end of the saw, i.e. carrying the blade, is raised and the saw tilted rearwardly. Ride on saws allow the user to ride on the saw instead of walking behind the saw.

### SUMMARY OF THE INVENTION

The present invention relates to concrete saws and, more particularly, a concrete saw that can cut on an angle or a kit that can be used to modify an existing concrete saw into a concrete saw that can cut on an angle. The present invention also relates to a method of cutting a concrete slab on an angle.

As referenced above, concrete saws are used in a variety of applications including, but not limited to, cutting and removing concrete from road surfaces and bridges. In order to safely cut and remove concrete from elevated roadways and/or bridges, it is important to prevent concrete slabs and/or debris from falling from the elevated structures to the areas below the elevated structures. The invention of this application relates to an improvement wherein the concrete saw of this application can cut concrete from an elevated road surface and/or bridge wherein the concrete being removed is prevented from falling from these elevated structures based on the cut alone. Moreover, the invention of this application achieves this without adding time consuming and/or costly implements at the jobsite to stop and/or prevent falling slabs and/or debris.

According to one aspect, the present invention provides a concrete saw that can produce an angled cut wherein the concrete being removed is prevented from falling based on the cut angle alone. No other structures are required. In greater detail, when a portion of a concrete slab is removed (“removed slab”), it is cut from the remaining concrete slab (“remaining slab”). The removed slab is cut along a slab cut line that separates the removed slab from the remaining slab to allow the removed slab to be physically removed from the site and replaced. In prior art concrete saws, the slab cut line is a vertical cut line (or at least perpendicular to an exposed face of the slab) wherein the cut edge of the removed slab is horizontally spaced from the cut edge of the remaining slab. Thus, the removed slab is free to move downwardly relative to the remaining slab and will move downwardly relative to the remaining slab unless the removed slab is independently supported by one or more structural arrangements. The invention of this application modifies the slab cut line such that the slab cut line is an angled slab cut line, which will be described more below. By making the slab cut line an angled slab cut line, the remaining slab can at least partially support the removed slab without independent support structures. In greater detail, the angled slab cut line is angled inwardly from a top extent at the top surface of the removed slab to a bottom extent at the bottom surface of the removed slab such that the top extent of the cut edge of the removed slab extends over top of the cut edge of the remaining slab. As a result, downward movement of the removed slab causes cut edge engagement between the cut edge of the removed slab and the cut edge of the remaining slab thereby allowing the remaining slab to temporality support the removed slab to allow for controlled removal of the removed slab.

According to another aspect, the present invention provides a platform or platform kit that can be used to modify an existing concrete saw to cut at the desired cut angle and to allow the existing mechanical structures of the existing concrete saw to be used for the blade height adjustment, the powering of the saw blade and the driving of the driven wheels to propel the concrete saw. More particularly, the platform of the invention of this application allows the existing concrete saw to produce a cut line that is angled as described above without substantial modification even though the existing saw is designed for a vertical cut.

In greater detail, the platform, or platform kit, includes a platform frame extending from a front platform extent to a rear platform extent. The platform further includes wheels fixed relative to the platform frame to allow the saw to be moved into position and to allow for movement during use. The platform wheels can include driven wheels to propel the concrete saw during movement and/or use. The platform wheels can include a front platform wheel set and a rear platform wheel set wherein the front or rear platform wheel sets can include driven wheels. Preferably, but not required, the rear wheels are the driven wheels. In that the platform can be configured to utilize the existing mechanical structures of the existing concrete saw, the front and rear wheel sets can be fixed wheel sets that have wheel axes that do not move relative to the platform frame.

The platform frame further includes an angled nest to support an existing concrete saw at a platform angle without substantial modification to the existing saw. By supporting the existing concrete saw at the platform angle, the existing mechanical structures of the existing concrete saw can be used for blade adjustment. In this respect, the blade height adjustment system of the existing concrete saw along with the saw blade of the existing saw are both at the platform angle wherein the existing blade height adjustment system can plunge the saw blade into a concrete slab and retract the blade from the concrete slab at the desired angle and without binding the blade in the kerf. Moreover, the hydraulic system of the existing blade height adjustment system can still be utilized.

The platform can further include platform front wheel supports to allow for controlled relative movement of the existing saw's front wheels relative to the platform to allow the existing blade height adjustment system of the existing saw to be used for blade cutting depth adjustment. As is known in the art, concrete saws can include a rear wheel set that is a driven wheel set and which propel the saw. The concrete saws can further include a front wheel set that is joined to the existing saw frame by way of a lifting system that moves the front wheels relative to the existing frame to raise and lower the front of the existing frame thereby raising and lowering the saw blade. The platform includes the front wheel supports to support the existing front wheel of the existing concrete saw and to allow controlled rolling movement of the front wheel relative to the platform to allow the existing blade height adjustment to control blade height. The platform angle provides this adjustment at the desired angle.

The platform front wheel supports can include platform front wheel channels to controllably support the front wheel set of the existing concrete saw to provide controlled rolling motion between the existing front wheel set and the platform. The front wheel channels allow the existing front wheel set to be kept in their existing mounted configuration wherein they are nested in corresponding platform front wheel channels of the platform. The platform front wheel channels can each extend between a front channel extent and a rear channel extent wherein the channels have a channel length that can be greater than the relative movement of the existing front wheel set relative to the platform to allow for the desired amount of blade height adjustment.

The platform front wheel channels can be a pair of parallel extending channels that each include a rolling wheel surface to allow for the controlled rolling motion of the existing front wheel set on the surface. The channels can further include at least one channel wall to help transversely secure the existing saw relative to the platform during use. Moreover, the front wheel channels can include inner and outer channel walls that extend parallel to one another to form an upwardly extending U-shaped channel that controllably supports the existing front wheels while allowing the needed relative rolling motion. By capturing or nesting the existing front wheels of the concrete saw in the wheel channels, the platform allows the wheels to roll and move within the wheel channels for blade actuation and allows this actuation at the blade angle between an upper blade adjustment extent and a lower blade adjustment extent.

According to further aspects of the present invention, the platform can further include a rear rotational or pivot mount to both help secure the existing saw relative to the platform and to allow controlled pivoting of the existing saw about an existing saw pivot axis. In this respect, the blade height adjustment system of the existing saw is produced by the existing front lift system and the movement of the existing front wheel set relative to the existing frame wherein the entire existing saw rotates about a rear pivot axis that is parallel to the saw blade axis. Therefore, the existing saw needs to be allowed to pivot relative to the platform to allow for blade height adjustment. The rear rotational mount therefore both secures the existing saw relative to the platform and allows for the needed saw pivot.

The rear rotational mount can include rear wheel hub mounts to allow the existing wheel hubs to secure the saw to the platform without substantial modification of the saw. In greater detail, the rear wheel hub mounts can be a pair of opposing rear hub mounts that extend upwardly from the platform frame and have inner mounting faces at the desired cut angle that face one another. In order to account for the platform angle, one wheel hub mount is higher than the other hub mount such that the hub mounts are in axial alignment with the rear pivot axis at the desired angle. Therefore, the rear wheel hub mounts can allow for pivotal movement of the existing saw about the rear pivot axis for blade height adjustment. In order to minimize the modifications needed to the existing saw, the rear wheel hub mounts can be configured to allow the existing rear wheel hubs of the existing saw to mount directly to the wheel hub mounts of the platform. This can be by either removing the rear wheel set from the existing saw and/or by nesting the platform over the rear wheel set without wheel removal.

As noted above, the platform can include wheels fixed relative to the platform frame to allow the saw to be moved into position and to allow for movement during use. These platform wheels can include driven wheels to propel the concrete saw during movement and/or use. According to certain aspects of the invention, the rear platform wheel set can include a platform power assist to drive the rear wheel set. The platform power assist can be configured to utilize existing wheel drive systems of the existing saw wherein the existing wheel drive systems can be used to help drive the platform without substantial modification to the existing saw. In this respect, and for example only, an electric rear wheel drive system can be re-routed so that the power feed of the electric system can be re-routed to an electric drive motor(s) on the rear wheel(s) of the platform. Therefore, use of the existing drive controls on the existing saw can be configured to drive the powered wheels of the platform. Similarly, for hydraulic drive systems, the hydraulic lines can be re-routed from the existing rear wheel set to the platform wheel set to allow the existing hydraulic drive system to power the platform. As a result, the platform and/or kit of this application can be used to easily modify an existing saw to cut on the desired angle and to function essentially as it did before modification. It has been found that this effectively and efficiently transforms existing saws into saws that can cut at the desired angle to achieve the desired angle cut. Moreover, the angle cut has been found to improve both the safety and efficiency associated with removing concrete slabs from elevated structures, such as roadways and the like.

According to further aspects of the invention, the existing saw can utilize a saw blade having a different diameter to compensate for the angle change of the existing machine.

According to yet further aspects of the invention, provided is a dedicated frame system wherein a concrete saw can be configured to cut at the desired angle discussed above. The dedicated frame can include all features of existing frame structures without detracting from the invention of this application. The dedicated frame includes wheels to allow the saw to be moved into position and to allow for movement during use as is the case for existing saws. The wheels can further include driven wheel(s) to propel the concrete saw during movement and/or use. The wheels can include a front wheel set and a rear wheel set wherein the front and/or the rear wheel sets can include the driven wheels. Preferably, but not required, the rear wheels are the driven wheels.

According to certain aspects, the invention can include a dedicate frame system that include a frame structure that is supported at an angle by way of the wheel sets and/or wheel set mounts. The frame structure can be at least similar to existing frame structures, but which includes wheel sets and/or mounts that produce the desired frame angle. Therefore, as with existing saws, the front wheel set can be joined to the frame by way of a lift system that moves the front wheel set relative to the frame for blade height adjustment at the desired angle thereby pivoting the dedicated frame about a rear pivot axis that is parallel to the saw blade axis to produce the desired angled cut. As a result, the saw blade of the saw mounted to the structural frame is at a desired angle wherein a blade height adjustment system can actuate the lift system to plunge the saw blade into a concrete slab and retract the blade from the concrete slab at the desired angle and without binding the blade in the kerf. Moreover, a power assist system, such as a hydraulically system, can be used to power the lift system that moves the front wheel set relative to the frame for the blade height adjustment.

The lift system can include a front wheel axil that joins the front wheel relative to one another for rotation about a common front wheel axis. The lift system can further include a pair of lift arms that can be journaled relative to the structural frame by front mount bearings. In addition, the lift system can include a frame rod to connect the pair of lift arms and strengthen the assembly. The frame rod can be joined to the mount bearing thereby forming a generally U-shaped pivot structure that pivots about a lift system axis. The lift system can further include downwardly extending front bearing mounts fixed relative to the structural frame to produce the needed pivot structure spacing between the structural frame and the pivot structure or assembly and/or to produce a mount point. In order to account for the angled lift of the structural frame, the lift arm can be joined relative to the front wheel axis by way of a pair of universal joints or the like that allow for more than one degree of freedom. In order to provide a desired angle of engagement with the front axil and/or to produce a mount point, the front wheel axil can include upward axil extensions extending between the universal joints and the front axil. Moreover, the front wheels and the lifting system for the front wheel can include any powered lift technology and/or wheel configuration known in the art without detracting from the invention of this application.

According to further aspects of the present invention, the frame structure can further include rear wheel mounts to both secure the rear wheels of the rear wheel set and to produce the desired frame angle for the angled cut. As noted above, the rear wheels can be the driven wheels of the saw. Moreover, the rear wheels can include any drive system and/or wheel configuration known in the art without detracting from the invention of this application. The rear wheel mounts can include differently sized rear wheel upward extensions that can, at least in part, produce the desired frame angle. The rear wheel mounts include a long mount and a short mount. The long and short mounts both include upper bearing supports to support rear mount pivot bearings that can be coaxial with the rear pivot axis. The structural frame can include downwardly extending rear bearing mounts fixed relative thereto to help produce the needed pivoting about the rear pivot axis and/or to produce a mount point. The mounts can further include one or more housing arrangements to prevent unwanted rotation of the mount relative to the saw frame. Yet even further, one or more hinge arrangements could be utilized instead of the bearing arrangements described above.

According to other aspects of the present invention, the frame angle can be an adjustable frame angle wherein the lifting system can be a front lift system that can be adjusted to both change the height of the structural frame relative to the front wheel and change the angle. And, the dedicated frame can include a rear lift system wherein the rear wheel mounts can be adjustable to change the frame angle.

According to even further aspects of the present invention, the front lift system can utilize a lift cylinder for each front wheel. And, the ends of lift cylinder would can have 1 or more degrees of freedom.

According to another aspects of the present invention, the rear lift system can include lift cylinder(s) for the rear wheels to change the saw from a straight cut to an angled cut.

According to even other aspects of the present invention, the front and/or rear lift systems can include the use of a 4-bar linkage that allows more than 1 degree of freedom.

According to yet even other aspects of the present invention, the front and/or rear lift systems can include the use of one or more cam mechanisms.

According to further aspects of the present invention, the front and/or rear lift systems can include one or more scissor mechanisms with a lift cylinder.

According to yet further aspects of the present invention, a wall saw could be attached with a pivoting track to achieve an angle.

According to yet even further aspects of the present invention, a pivoting arm attachment could be used in place of a blade shaft.

According to yet other aspects of the present invention, provided is a method of cutting a concrete slab in an elevated structure wherein the concrete being removed is prevented from falling based on the cut angle alone. The method including the steps of using a concrete saw to produce a V-Cut to remove a slab of concrete wherein the portion of the concrete slab being removed is the “removed slab” and portion of the concrete slab that is not removed is the “remaining slab”. The method including the step of making a first angled cut that forms a first portion of the V-cut. The first angled cut being cut along a first slab cut line that separates a first side of the removed slab from a first portion of the remaining slab. The first angled cut being at a first cut angle such that the first angled cut angles inwardly from a top extent at the top surface of the first side of the remove slab to a bottom extent at the bottom surface of the removed slab wherein the top extent of the first slab cut line of the first side of the removed slab extends over top of the cut edge of at least a portion of the first portion of the remaining slab. The method further including the step of making a second angled cut that forms a second and opposite portion of the V-cut. The second angled cut being cut along a second slab cut line that separates a second side of the removed slab from a second portion of the remaining slab. The second angled cut being at a second cut angle that is opposition of the first cut angle. The second cut angles inwardly from the top extent at the top surface of the second side of the remove slab to a bottom extent at the bottom surface of the removed slab wherein the top extent of the second slab cut line of the second side of the removed slab extends over top of the cut edge of at least a portion of the second portion of the remaining slab. As a result, downward movement of the removed slab will cause the first and second cut edges to nest in the remaining slab edges based on the engagement between the cut edges of the removed slab and the cut edges of the remaining slab thereby allowing the remaining slab to temporality support the removed slab to allow for controlled removal of the removed slab.

These and other objects, aspects, features, refinements and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 is a front perspective view of an exemplary concrete saw platform according to certain aspects of the invention and shown in a lower position;

FIG. 2 is a front perspective view of the platform shown in FIG. 1 that includes a concrete saw attached thereto showing the platform and the saw in the lower position;

FIG. 3 is a front elevational view of the platform and concrete saw shown in FIG. 2 also shown in the lower position;

FIG. 4 is a front perspective view of the platform shown in FIG. 1 that includes a concrete saw attached thereto showing the platform and the saw in an upper position;

FIG. 5 is a front elevational view of the platform and concrete saw shown in FIG. 4 also shown in an upper position;

FIG. 6 is a side perspective view of an exemplary concrete saw having a dedicated frame according to other aspects of the invention and shown in a lower position;

FIG. 7 is a front elevational view of the concrete saw shown in FIG. 6 also shown in the lower position;

FIG. 8 is a side perspective view of the concrete saw shown in FIG. 6 showing the saw in an upper position;

FIG. 9 is a front elevational view of the concrete saw shown in FIG. 8 also shown in the lower position;

FIG. 10 is a sectional view of a V-cut wherein the removed slab is illustrated in its original position;

FIG. 11 the sectional view of the V-cut shown in FIG. 10 wherein the removed slab has fallen into and nested in the cut portions of the remaining slabs; and,

FIG. 12 is a side elevational view of a track system according to yet other embodiments of the invention.

### DESCRIPTION OF PREFERRED EMBODIMENTS

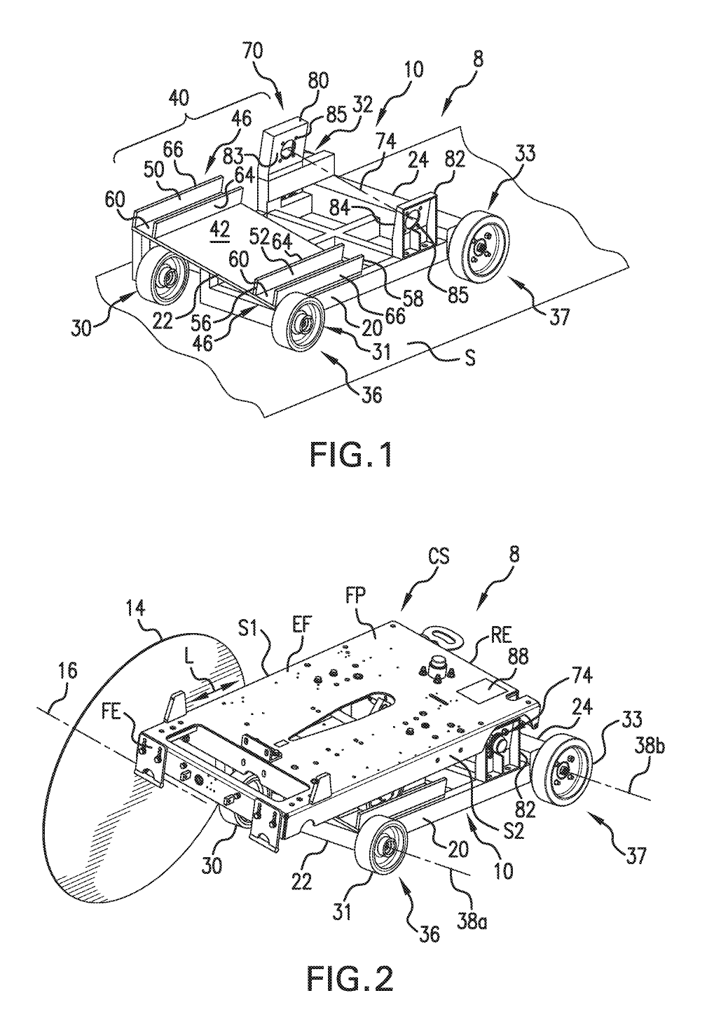

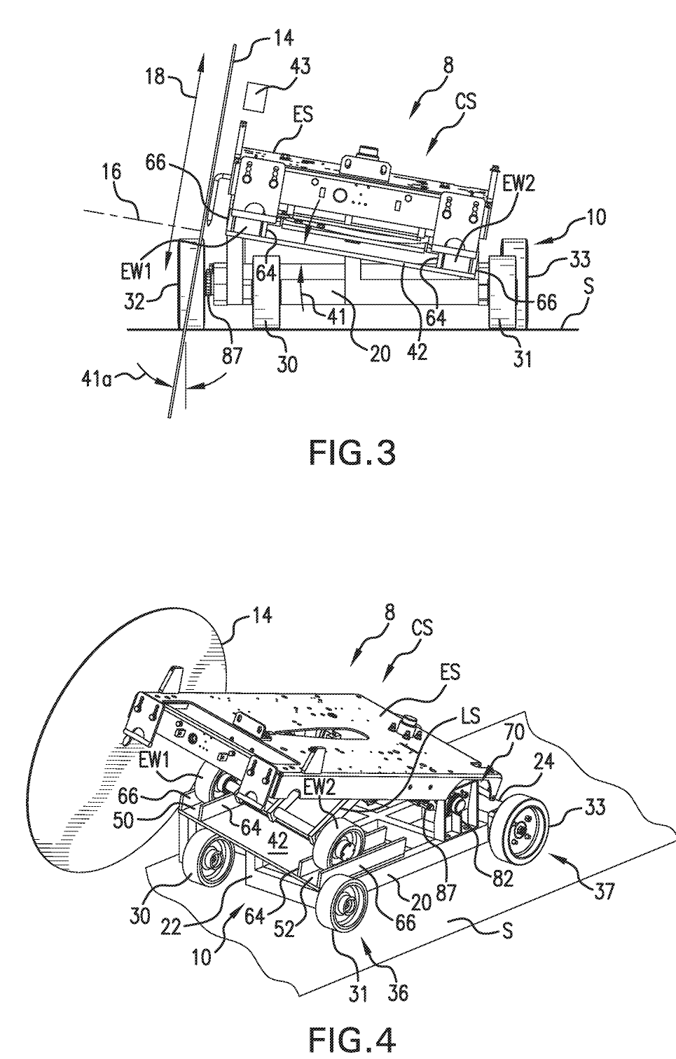

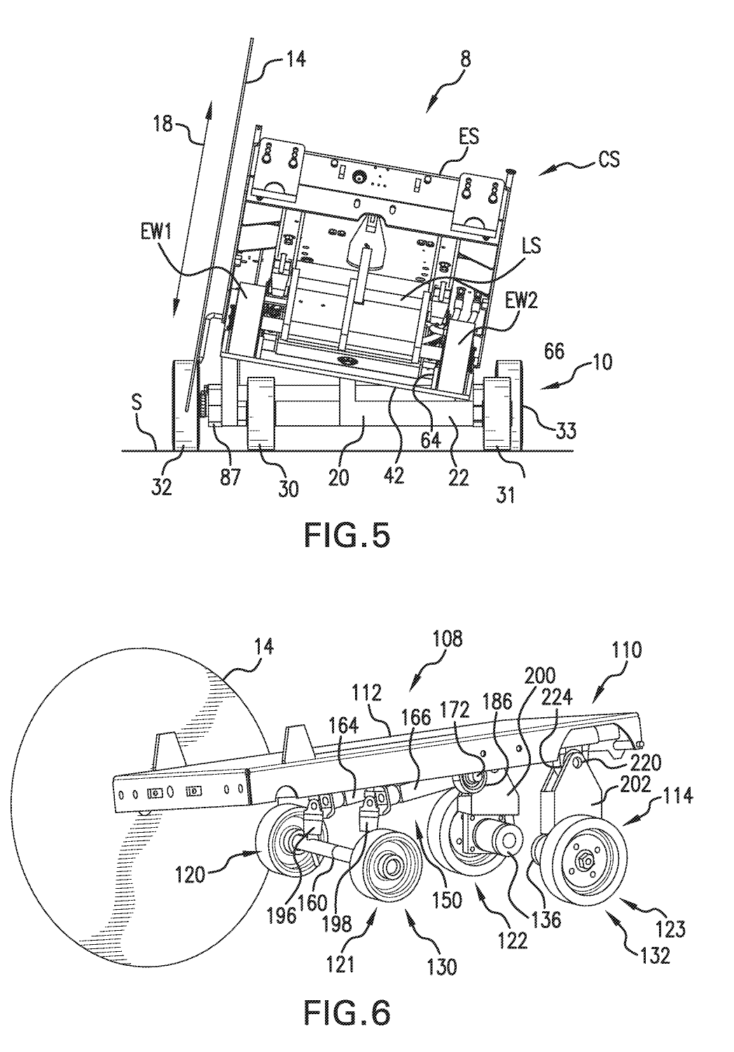

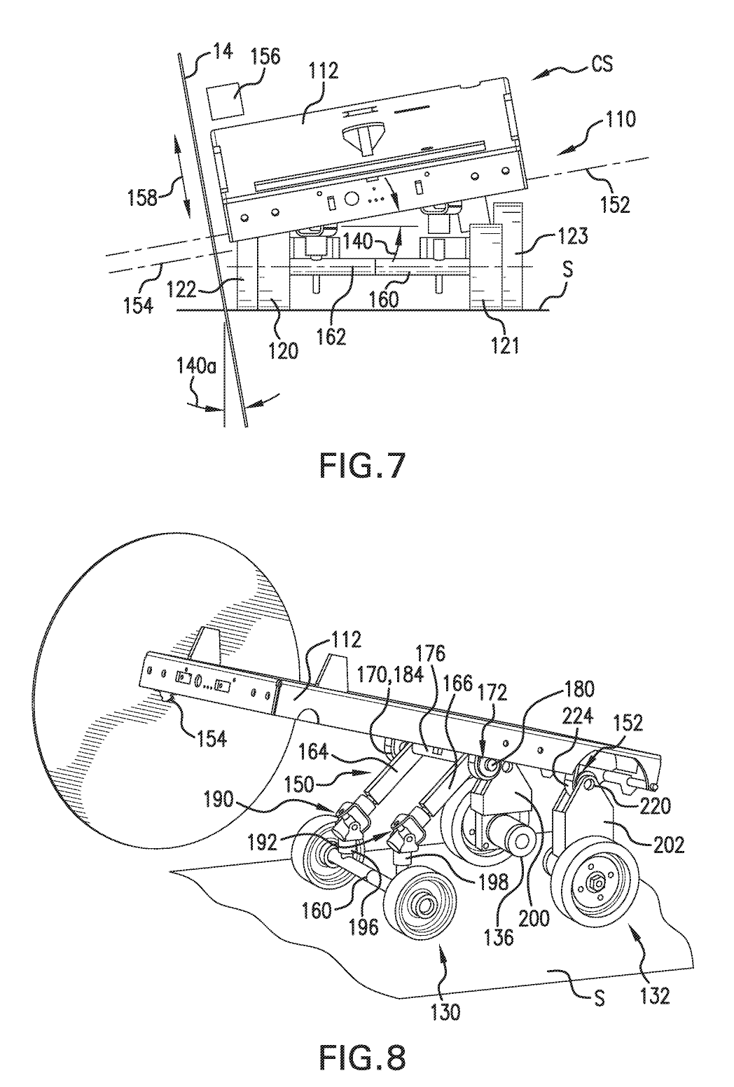

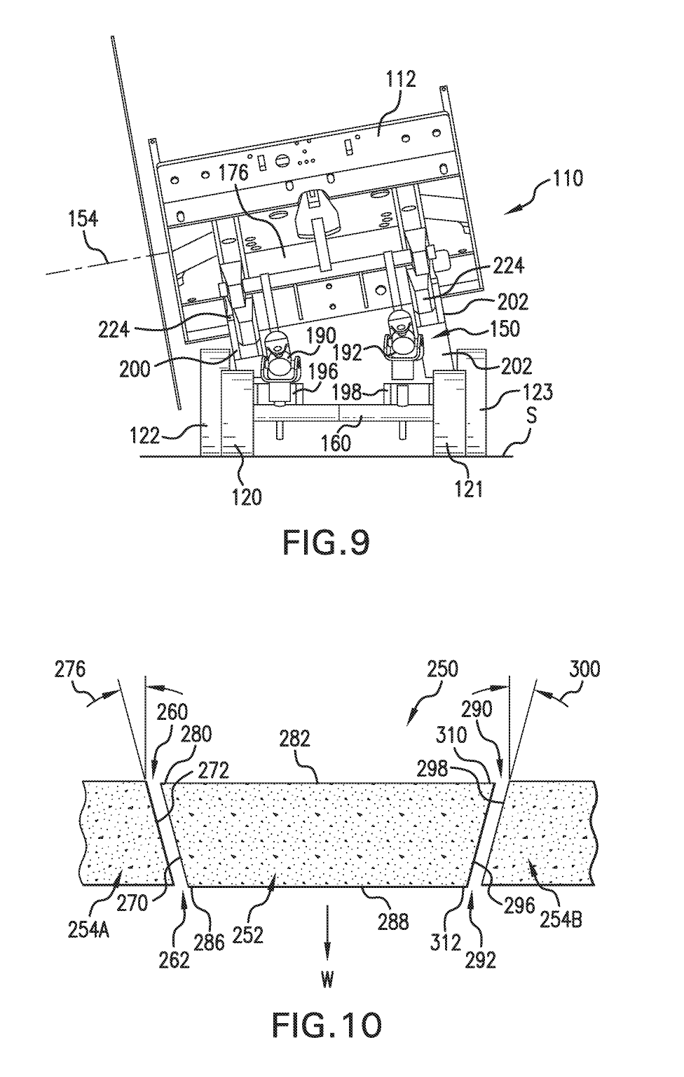

Referring now to the drawings wherein the showings are for the purpose of illustrating preferred and alternative embodiments of the invention only and not for the purpose of limiting the same, FIG. 1 shows a concrete saw 8 having a platform or platform structure. According to certain aspects of the present invention, and as shown in FIGS. 2-5, the platform can be a unified frame structure 10 with an existing concrete saw CS secured relative thereto. However, in that the invention of this application can be used on a wide range of concrete saws and concrete cutting systems, the saw technology itself is not shown or described in detail in the interest of brevity. Conversely, the drawings and the description below are in relation to the frame portions only in the interest of brevity. However, this is not to be interpreted to limit the invention of this application or this disclosure in that the invention can be used on a wide range of saws and these saws are known by those skilled in the art.

In greater detail, the present invention relates to concrete saws and, more particularly, to a concrete saw that can cut on an angle and/or a platform or platform kit that can be used to modify an existing concrete saw into a concrete saw that can cut on an angle. And, the angle can be any desired angle for the purposes disclosed in this application or for other purposes. However, the invention of this application has been found to work particularly well in connection with cutting and removing concrete from elevated road surfaces and/or bridges. In order to safely cut and remove concrete from elevated roadways and/or bridges, it is important to prevent concrete slabs and/or debris from falling from the elevated structures to the areas below the elevated structures.

According to one set of embodiments, saw 8 includes existing saw CS mounted relative to platform or platform kit 10 that, as is shown, can be a unified platform structure. Discussed more below are alternative platform structures that can include multiple platform portions. With respect to platform 10, this platform structure can be used to easily modify an existing concrete saw to cut at the desired cut angle with minimal modifications to the existing saw. This can allow for the use of virtually all of the existing mechanical and operating structures of the existing concrete saw including those used for the blade height adjustment, the powering of the saw blade and/or the driving of the driven wheels to propel the concrete saw. More particularly, platform 10 allows existing concrete saw CS to have a saw blade 14 that rotates about a saw blade axis 16 that is not parallel to underlying surface S to produce a cut line that is angled, not perpendicular or vertical, to the underlying surface and without substantial modification even though the existing saw is designed for a vertical cut. Moreover, it allows saw blade to be moved or plunged in directions 18 that is perpendicular to saw blade axis 16 and the saw frame, but not perpendicular to surface S without jamming the saw in the cut line.

In greater detail, one embodiment saw 8 includes platform 10 that includes a platform frame 20 to support existing saw CS. Platform frame 20 extending from a front platform extent 22 to a rear platform extent 24. The platform further includes wheels 30-33 fixed relative to the platform frame to allow the saw to be moved into position and to allow for movement during use. The platform wheels can include driven wheels to propel the concrete saw during movement and/or use. The platform wheels can include a front platform wheel set 36 and a rear platform wheel set 37 wherein the front and/or rear platform wheel sets can include driven wheels. Preferably, but not required, the rear wheels are the driven wheels. In that the platform can be configured to utilize the existing mechanical structures of the existing concrete saw, the front and rear wheel sets of the platform can be fixed wheel sets that have wheel axes 38a and 38b that do not move relative to the platform and which are parallel to surface S.

The platform frame further includes an angled structure, which in this set of embodiments, is an nest 40 to support an existing concrete saw at a platform angle 41 without substantial modification to produce cut angle 41a that can correspond with platform angle 41. Nest 40 can extend beyond frame extents, but this is not required. By supporting the existing concrete saw at the platform angle, the existing mechanical structures of the existing concrete saw can be used for blade adjustment in directions 18. In this respect, a blade height adjustment system 43 (schematically shown only) of the existing concrete saw along with the saw blade of the existing saw are positioned at the platform angle wherein the existing blade height adjustment system can plunge the saw blade into a concrete slab in directions 18 and retract the blade from the concrete slab in directions 18, which is at the desired angle and without binding the blade in the kerf. In that the blade height adjustment system can be any adjustment system, which are known in the art, details are not provided in the interest of brevity. Moreover, the hydraulic system of the existing blade height adjustment system can still be utilized.

Nest 40 can include a wide range of configurations without detracting from the invention of this application including a nest with separate components, which will be discussed more below. Nest 40 is part of a more unified frame structure configuration that includes front saw wheel supports 42 to allow for controlled relative movement of the existing saw's front wheels EW1 & EW2 relative to the platform to allow the existing blade height adjustment system of the existing saw to be used for blade cutting depth adjustment. As is known in the art, existing saws can include a rear wheel set that is a driven wheel set and which propels the saw. The existing saws can include a front wheel set that is joined to the existing saw frame by way of a lifting system LS that moves front wheels EW1 & EW2 relative to an existing frame EF to raise and lower the front of the existing frame thereby raising and lowering the saw blade relative to surface S. Existing frame EF generally extends in a frame plane FP that is generally parallel to saw blade axis 16. In that the existing saw frame can be any saw frame without detracting from the invention of this application, it will not be discussed in detail in the interest of brevity. As is shown, existing frame EF extends between a front end FE and a rear end RE. The existing saw frame includes sides S1 and S2 extending between the front end and rear end and that extend in a longitudinal direction L that is generally parallel to plane FP. Thus, the front end faces a front side of the concrete saw and the rear end faces a rear side of the concrete saw. Front saw wheel supports 42 can includes front wheel guides 46 to controllably support the existing front wheel EW1 and EW2 of the existing concrete saw CS and to allow controlled rolling movement of the front wheel relative to the platform to allow the blade height adjustment to control blade height. The platform angle provides this adjustment at the desired angle.

The guides can be a wide range of configuration without detracting from the invention. As is shown, guides 46 include a pair of wheel channels 50, 52 for the controlled support of the saw's front wheel set. These provide the guided or controlled rolling motion between the existing front wheel set and the nest of the platform. Moreover, the front wheel channels allows the existing front wheel set to be kept in their existing mounted configuration wherein they are merely nested in the corresponding wheel channels of the platform. The front wheel channels can each extend between a front channel extent 56 and a rear channel extent 58 wherein the channels have a channel length that is equal to or greater than the relative movement of the existing front wheel set relative to the platform in longitudinal direction L to allow for the desired amount of blade height adjustment between the lower extent shown in FIGS. 2 & 3 and the upper extent shown in FIGS. 4 & 5.

Platform front wheel channels 50, 52 can be a pair of parallel extending channels that each include a rolling wheel surface(e) 60 to allow for the controlled rolling motion of the existing front wheel set. The channels can further include at least one channel wall to help secure the existing saw relative to the platform during use. As is shown, the front wheel channels include an inner channel wall 64 and an outer channel wall 66 that extend parallel to one another to form an upwardly extending U-shaped channel that controllably supports the existing front wheels while allowing the needed relative rolling motion. By capturing the existing front wheels of the concrete saw in the wheel channels, the platform allows the wheels to roll and move within the wheel channels for blade actuation at blade angle 41a in directions 18 between the upper blade adjustment extent and the lower blade adjustment extent while helping secure the concrete saw relative to the platform.

Platform 10 can further include a rear rotational mount 70 system to both help secure the existing saw relative to the platform and allow controlled pivotal action of the existing saw about an existing saw pivot axis 74. In this respect, the blade height adjustment system of the existing saw is produced by the existing front lift system and the movement of the existing front wheel set relative to the existing frame wherein the entire existing saw rotates about rear pivot axis 74 that is parallel to saw blade axis 16. Therefore, the existing saw needs to be allowed to rotate relative to the platform to allow for blade height adjustments in directions 18. The rear rotational mount therefore works with front wheel supports 42 to form angled nest 40 wherein nest 40 both secures the existing saw relative to the platform and allows for the needed saw pivot about axis 74 for saw blade plunging movement in directions 18.

The rear rotational mount can include a wide range of mounts without detracting from the invention of this application. As is shown, platform 10 includes rear wheel hub mounts 80 & 82 to allow for use of the platform to work with the existing saw without substantial modification. In greater detail, the rear wheel hub mounts can be a pair of opposing rear hub mounts 80 & 82 that extend upwardly from the platform frame at the desired cut or platform angle and wherein hub mount 80 is higher than hub mount 82. Moreover, hub mounts 80 & 82 can be angled wherein the hub mounts surfaces 83 and 84 are parallel to one another and in axial alignment with the rear pivot axis. Therefore, the rear wheel hub mounts can allow for rotation of the existing saw about rear pivot axis 74 for blade height adjustment. In order to minimize the modifications needed to the existing saw, the rear wheel hub mounts can include lug holes 85 that are in the same pattern as the wheel hubs for the rear wheels (not shown) of the existing concrete saw. This configuration allows the existing rear wheel hubs of the existing saw to mount directly to the wheel hub mount by merely removing the rear wheel set from the existing saw. Moreover, the existing rear wheels from the concrete saw could be used as wheels 32 and 33 of the saw platform, but this is not required. According to yet another set of embodiments, the hub mounts of the platform can be configured to capture the existing wheels of the saw in a cradle or nest which produces the desired angle of the saw. In this set of embodiments, the wheels do not need to be removed.

As noted above, the platform can include wheels (30-33) fixed relative to the platform frame to allow the saw to be moved into position and to allow for movement during use on surface S. These platform wheels can include driven wheels to propel the concrete saw during movement and/or use. Accordingly, the rear platform wheel set 37 can include a platform power assist(s) 87 to drive the rear wheel set. The platform power assist can be configured to utilize existing wheel drive systems 88 (schematically shown only) of the existing saw wherein the existing wheel drive systems can be used to help drive the platform without substantial modification to the existing saw. In this respect, and for example only, an electric rear wheel drive system can be re-routed so that the power feed of the electric drive system of the existing saw is re-routed to platform power assist(s) 87 that is in the form of an electric drive motor(s) that is(are) operably connected to the rear wheel(s) 32 and/or 33 of the platform. Therefore, use of the existing drive controls on the existing saw can be configured to drive the powered wheels of the platform. Similarly, for hydraulic drive systems, the hydraulic lines can be re-routed from the existing rear wheel set to the power assist of the platform wheel set to allow the existing hydraulic drive system to power the platform. As a result, the platform and/or kit of this application can be used to easily modify the existing saw to cut on the desired angle and to function essentially as it did before modification. It has been found that this effectively and efficiently transforms existing saws into saws that can cut at the desired angle to achieve the desired angle cut and improve both the safety and efficiency associated with removing concrete slabs from elevated structures, such as roadways and the like (not shown). Moreover, the tracking and/or steering of the platform can utilize the same or similar technologies as existing saw systems and these systems can be configured to work based on the controls of the existing saw. As a result, the use of the platform requires minimal training in that it uses the operating systems of the existing saw.

Saw 8 can utilized saw blade 14 having a different diameter to compensate for the effects of the angle change of the existing machine. In the embodiments shown, saw blade 14 has a larger diameter in view of the angle of the shown platform. Moreover, according to yet other embodiments, the blade transmission of the saw could be altered (raised or lowered) to minimize the needed change to the blade diameter. However, this modification could necessitate modifications to the drive belts.

Platform angle 41 and thus blade angle 41a can be a wide range of angles between 0 degrees (vertical) and 90 degrees without detracting from the invention of this application. In one embodiment, the platform angle is less than 45 degrees. In a further embodiment, the platform angle is in the range of 5 degrees to 30 degrees. More preferably, the platform angle is in the range of 5 degrees to 15 degrees. Yet further, it has been found that the platform angle is more preferably approximately 10 degrees.

According to another set of embodiments, an existing saw could be modified without a platform by changing the wheel diameter of the wheels of the existing saw (not shown). In greater detail, the wheels from one side of an existing saw could be replaced with wheels having a different outside diameter to create a non-vertical blade angle. In one set of embodiments, the different diameters could be larger diameters wheels on one side of the saw to create the angle needed to produce the angled cut. Similarly, and with reference to FIG. 12, the wheels of the saw could be replaced with one or more track systems wherein these track systems can be configured to raise/lower one side of the existing saw and/or to raise/lower the front/rear of the saw. As can be appreciated, raising one side of the saw can be used to create the needed angle while raising/lowering the front of the saw can be used to create the changes in the blade height for blade depth control. In this set of embodiments, the tracks can transform from a lowered track arrangement 92 to a raised track arrangement 94. These transforming tracks can be used on the rear and/or front of the saw to replace the existing wheel set to produce any needed wheel assembly height.

According to even another embodiment, an existing saw could be modified without a platform by use of a floating head arrangement (not shown), that can operate similar to the floating head of a chop saw wherein there is a pivoting blade shaft. This can include the blade being driven by a hydraulic motor fixed relative to the blade and/or blade assembly wherein the hydraulic motor moves with the blade and moves relative to the saw frame and the saw's engine that drives the hydraulic pump. In this embodiment, the blade assembly, which includes the hydraulic saw motor and the saw blade, can have multiple degrees of freedom.

According to yet other embodiments, an existing saw could be modified without a platform by use of a blade transmission (not shown) that connects via a U-joint to a secondary shaft/transmission that allows the blade to telescope as it is entered into the cut.

According to yet further embodiments of the invention of this application, a saw 108 can include a frame system 110 wherein a concrete saw can be configured to cut at the desired angle discussed above. Again, the invention of this application can be used on a wide range of concrete saws and concrete cutting systems. Accordingly, in this set of embodiments, the details of the saw and the saw technology itself are not shown or described in detail in the interest of brevity. Conversely, the drawings and the description below are in relation to only the frame portion of the saw and the invention in relation the frame portion. Moreover, as with all embodiments, even the frame portion of the saw is not to be limited to the examples shown. Again, the examples shown herein are not to be interpreted to limit the invention of this application or this disclosure in that the invention can be used on a wide range of concrete saws and concrete saw frames.

More particularly, saw 108 includes frame system 110 having a frame portion 112 and a platform portion 114, which is a multi-portion platform. Again, frame portion can include all features of existing frame structures without detracting from the invention of this application. However, in this set of embodiments, platform portion is a multi-piece platform that will be discussed more below.

Frame system 110 includes wheels 120-123 to allow the saw to be moved into position and to allow for movement of the saw during use on surface S as is the case for existing saws. The wheels can further include driven wheel(s) to propel the concrete saw during movement and/or use. The wheels can include a front wheel set 130 and a rear wheel set 132 wherein the front or rear wheel sets can include the driven wheels. As is shown, rear set 132 includes the driven wheels that can be powered by drive units 136, which can be any type of drive unit(s) known in the art. Moreover, the drive wheels and/or directional wheels can be powered and/or controlled by existing systems of the concrete saw for saws that are modified to include platform 114, which is discussed above in greater detail.

Frame portion 112 can be permanently supported at a frame angle 140 by way of platform 114 and the wheel sets and/or wheel set mounts of the platform. Frame angle 140 can be used, at least in part, to form blade angle 140a, which is discussed in greater detail above. Moreover, as will be discussed more below, the frame angle of this embodiment, and others, could be variable and/or adjustable. As with the platform above, frame angle 140 and blade angle 140a can be a wide range of angles between 0 degrees and 90 degrees without detracting from the invention of this application. In one embodiment, the frame angle is less than 45 degrees. In a further embodiment, the frame angle is in the range of 5 degrees to 30 degrees. More preferably, the frame angle is in the range of 5 degrees to 15 degrees. Yet further, it has been found that the frame angle is more preferably approximately 10 degrees.

The frame structure can be at least similar to existing frame structures, but which includes platform portions 114 having wheel sets and/or mounts that produce the desired frame angle. Platform 114 can further include a lift system 150 having front wheel set 130 that can be joined to the frame by lift system 150. Lift system 150 can utilize any lifting technology known in the art for its movement and can form a portion of platform 114 in that it is also configured at the platform angle. In this respect, one of the wheels of front wheel set 130 is spaced further from the saw frame than the other wheel of this wheel set and this offset spacing corresponds to the platform angle. Accordingly, actuation of lift system 150 moves the front wheel set relative to the frame for blade height adjustment at the desired angle thereby rotating the dedicated frame about a rear pivot axis 152 that is parallel to a saw blade axis 154 to produce the desired cut depth. As a result, the saw blade of the saw mounted to the structural frame is at the frame angle wherein a blade height adjustment system 156 (schematically shown only), which can be in an existing concrete saw being converted to an angled saw according to this invention, can actuate the lift system to plunge the saw blade into a concrete slab and retract the blade from the concrete slab in direction 158 and at the desired angle without binding the blade in the kerf. Moreover, a power assist system of system 156, such as a hydraulically system, can be used to power the lift system that moves the front wheel set relative to the frame for blade height adjustment.

The lift system can include a front wheel axil 160 that joins front wheels 120 & 121 relative to one another for rotation about a common front wheel axis 162. The lift system can further include a pair of lift arms 164 & 166 that can be journaled relative to the structural frame by front mount bearings 170 & 172, respectively. In addition, lift system 150 can include a frame rod 176 to connect the pair of lift arms and strengthen the assembly. The frame rod can be joined to the mount bearing thereby forming a generally U-shaped pivot structure that pivots about a lift system axis 180. The lift system can further include downwardly extending front bearing mounts 184 & 186 fixed relative to the structural frame to produce the needed pivot structure spacing between the structural frame and the pivot structure or assembly. In order to account for the angled lift of the structural frame, the lift arm can be joined relative to the front wheel axis by way of a pair of universal joints or the like 190 & 192. In order to provide a desired angle of engagement with the front axil and/or to produce a mount point, the front wheel axil can include upward axil extensions 196 & 198 extending between the universal joints and the front axil. Moreover, the front wheels and the lifting system for the front wheel can include any powered lift technology and/or wheel configuration known in the art without detracting from the invention of this application. In addition, the frame system can include a wide range of tracking and/or steering systems without detracting from the invention of this application.

Platform 114 further includes rear wheel mounts 200 and 202 to both secure the rear wheels of the rear wheel set and to produce the desired frame angle for the angled cut. As noted above, the rear wheels can be the driven wheels of the saw. Moreover, the rear wheels can include any drive system 136 and/or wheel configuration known in the art without detracting from the invention of this application. Moreover, the rear wheels can be powered based on components and systems from an existing concrete saw that is modified according to the invention of this application. The rear wheel mounts can include differently sized rear wheel upward extensions and/or extendable rear mounts that can at least in part produce the desired frame angle. As is shown, the rear wheel mounts include a long mount 202 and a short mount 200; however, this could be reversed. The long and short mounts both include upper bearing supports 220 to support rear mount pivot bearings that can be coaxial with rear pivot axis 152. The structural frame can include downwardly extending rear bearing mounts 224 fixed relative thereto to help produce a mounting point for the frame, the needed spacing below the outer frame rale and/or the pivoting about the rear pivot axis. The mounts can further include one or more housing arrangements (not shown) to prevent unwanted rotation of the mount relative to the saw frame. This can include, but is not limited to, a lower frame assembly or structure (not shown), that supports and/or secures the lower portions of the front and/or rear wheel assemblies to prevent unwanted rotation of the assemblies relative to the frame. With respect to the rear wheel assembly, this can include a frame structure that prevents rotation of mounts 200 and 202 about bearing supports 220. Yet further, this assembly or structure can extend between the front and rear wheel assemblies to better support both assemblies with a single structure or assembly. Moreover, one or more hinge arrangements (not shown) could be utilized instead of the bearing arrangements described above.

Frame 110 can also be an adjustable frame wherein the frame angle can be adjusted. As a result, the frame can allow for both the adjustment of the blade height and the blade angle. In these embodiments, the lifting system can be a front lifting system that can be adjusted to both change the height of the structural frame relative to the front wheels to change blade depth and side to side to change blade angle. In addition, frame 110 can further include a rear lifting system wherein the rear wheel mounts can be adjustable rear mounts to change the frame angle. In both cases, the front and rear supports can be adjustable independently from one side to the other side to at least in part change the frame angle.

According to one set of embodiments, the front lift system can utilize a lift cylinder for each front wheel and/or front wheel mount. In addition, the ends of lift cylinder could have 1 or more degrees of freedom.

According to other embodiments, the rear lift system can include lift cylinder(s) for the rear wheels to change saw from a straight cut to an angled cut.

According to even yet other embodiments, the front and/or rear lift systems can include the use a 4-bar linkage that allows more than 1 degree of freedom.

According other embodiments, the front and/or rear lift systems can include one or more scissor mechanisms with a lift cylinder.

According to yet even other embodiments, the front and/or rear lift systems can include the use of one or more cam mechanisms.

According to yet other embodiments, a wall saw could be attached with a pivoting track to achieve a blade angle.

According to yet even further embodiments, a pivoting arm attachment could be used in place of a blade shaft.

With reference to FIGS. 10 & 11, The invention also relates to a method of cutting a concrete slab in an elevated structure wherein the concrete being removed is prevented from falling based on the cut angle alone. The method including the steps of using a concrete saw to produce a V-Cut 250 to remove a slab of concrete wherein the portion of the concrete slab that is being removed is a “removed slab” 252 and the portion of the concrete slab that is not removed is a “remaining slab” 254. As is shown, there are two remaining slabs 254A and 254B that can be a part of the same slab or separate slabs without detracting from the invention of this application. The method including the step of making a first angled cut that forms a first cut portion 260 of V-cut 250. The first angled cut being cut along a first slab cut line 262 that separates a first side 270 of removed slab 252 from a first side 272 of remaining slab 254A. The first angled cut being at a first cut angle 276 such that the first angled cut angles inwardly from a top extent 280 at a top surface 282 of the first side of the remove slab to a bottom extent 286 at a bottom surface 288 of removed slab 252 wherein the top extent of the first slab cut line of the first side of the removed slab extends over top of the cut edge of at least a portion of first side 272 of the remaining slab. Again, cut angle 276 can be a wide range of angles as is reference above without detracting from the invention of this application. In a preferred set of embodiments, cut angle 276 is preferably in the range of 5 degrees to 15 degrees as is shown in these figures, but this is not required.

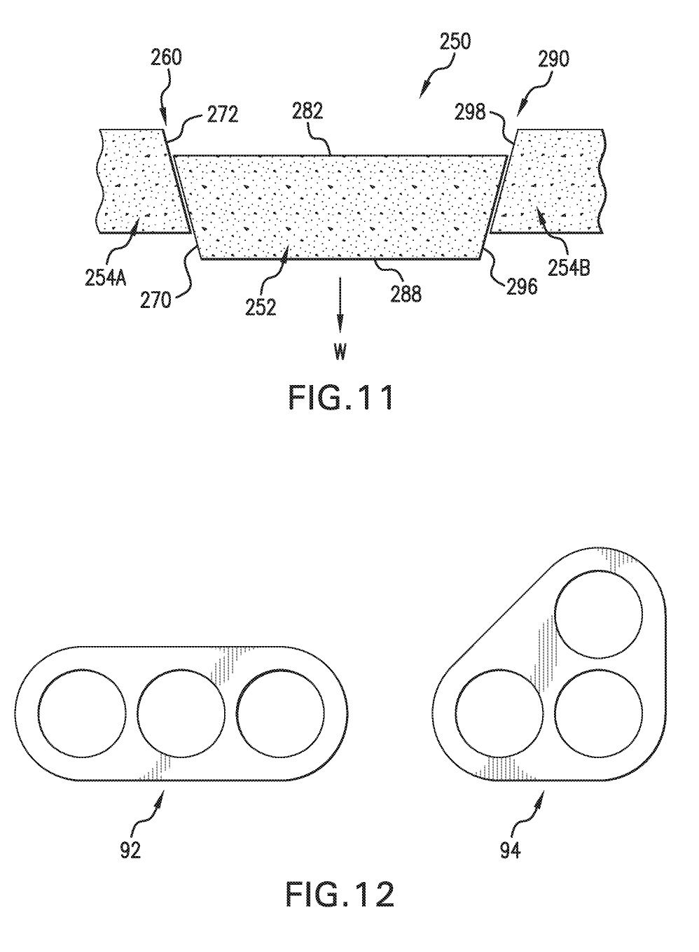

The method further including the step of making a second angled cut that forms a second and generally opposite cut portion 290 of V-cut 250. The second angled cut being cut along a second slab cut line 292 that separates a second side 296 of the removed slab from a second side 298 of remaining slab 254B. The second angled cut being at a second cut angle 300 that is opposite of first cut angle 276. While not required second cut angle 300 can be both opposite of and equal to first cut angle 276. As with cut angle 276, cut angle 300 is preferably in the range of 5 degrees to 15 degrees, but this is not required. The second cut angles inwardly from a top extent 310 at top surface 282 of the remove slab to a bottom extent 312 at bottom surface 288 of removed slab 252 wherein the top extent of the second slab cut line of the second side of the removed slab extends over top of the cut edge of at least a portion of second side 298 of remaining slab 254B. As a result, downward movement of the removed slab, as is shown in FIG. 11, will cause the first and second cut edges 270 and 296 of removed slab 252 to nest in remaining slab edges 272 and 298, respectively, based on gravity alone and the engagement between the cut edges 270 and 272 and cut edges 296 and 298 of the slabs thereby producing a temporality support of the removed slab to allow for controlled and safe removal of the removed slab.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

It is claimed:

1. A concrete saw configured to cut an underlying surface at an angle, the concrete saw comprising:
a saw frame extending between a front end and a rear end, the saw frame includes sides extending between the front end and the rear end that extend in a longitudinal direction, the front end facing a front side of the concrete saw and the rear end facing a rear side of the concrete saw, the saw frame generally extending in a saw frame plane that is generally parallel to the longitudinal direction;
a saw blade that is rotatably mounted relative to the saw frame and configured to be driven wherein the saw blade is rotatable about a saw blade axis, the saw blade axis being generally parallel to the saw frame plane;
a motor supported by the saw frame, the motor having a motor output shaft for driving the saw blade;
a platform structure configured to support the saw frame, the platform structure having at least one rear wheel and at least one front wheel for facilitating movement of the concrete saw on an associated surface, the at least one front wheel rotatable about a first wheel axis and the at least one rear wheel rotatable about a rear wheel axis, the platform structure including an angled support structure, the angle support structure supporting the saw frame relative to the platform structure at a platform angle.
a blade height adjustment system for adjusting a blade cutting depth, the blade height adjustment system being operably connected to the saw frame and extending between the saw frame and at least a portion of the platform structure wherein movement of the blade height adjustment system moves the saw frame relative to the platform structure about a saw pivot axis that is parallel to the saw frame plane to produce movement of the saw blade relative to the associated surface in a plunge direction that is perpendicular to the saw frame plane, the platform structure causing the plunge direction to be at the platform angle relative to the associated surface to allow the saw blade to cut into the associated surface at a cut angle.

2. The concrete saw of claim 1, wherein the blade height adjustment system includes a lifting system operably joined relative to the saw frame and including at least one lifting system wheel, the blade height adjustment system selectively moving the at least one lifting system wheel relative to the saw frame, the platform structure including a saw wheel support shaped to receive the at least one lifting system wheel and allowing relative rolling movement of the at least one lifting system wheel in the saw wheel support as the blade height adjustment system moves the at least one lifting system wheel relative to the saw frame and the saw blade moves in the plunge direction.

3. The concrete saw of claim 2, wherein the saw wheel support includes a wheel channel shaped to receive the at least one lifting system wheel and allowing controlled relative movement of the at least one lifting system wheel in the saw wheel support as the saw blade moves in the plunge direction.

4. The concrete saw of claim 3, wherein the wheel channels has a U-shaped cross-sectional configuration.

5. The concrete saw of claim 3, wherein the at least one lifting system wheel includes a first lifting system wheel and a second lifting system wheel, the wheel channel includes a first wheel channel shaped to receive the first lifting wheel and a second wheel channel shaped to receive the second lifting wheel.

6. The concrete saw of claim 5, wherein the first and second wheel channels have a U-shaped cross-sectional configuration.

7. The concrete saw of claim 1, wherein the saw frame has includes rear frame wheel mounts for selectively securing associated rear saw wheels relative to the saw frame, the rear frame wheel mounts including a first rear frame wheel mount and a second rear frame wheel mount, the platform structure including a first rear platform mount that is selectively securable relative to the first rear frame wheel mount and a second rear platform mount that is selectively securable relative to the second rear frame wheel mount, the first rear platform mount being spaced further from the associated surface corresponding to the platform angle, the first and second rear frame wheel mounts and the first and second rear platform mounts further securing the saw frame relative to the platform structure, the rear platform mounts allowing for pivotal movement about the saw pivot axis.

8. The concrete saw of claim 7, wherein the rear frame wheel mounts includes wheel hub mounts and the rear platform mounts being securable to the wheel hub mounts similarly as the associated rear saw wheels after they are removed.

9. The concrete saw of claim 7, wherein the blade height adjustment system includes a lifting system operably joined relative to the saw frame and including at least one lifting system wheel, the blade height adjustment system selectively moving the at least one lifting system wheel relative to the saw frame, the platform structure including a saw wheel support shaped to receive the at least one lifting system wheel and allowing relative rolling movement of the at least one lifting system wheel in the saw wheel support as the blade height adjustment system moves the at least one lifting system wheel relative to the saw frame and the saw blade moves in the plunge direction.

10. The concrete saw of claim 9, wherein the saw wheel support includes a wheel channel shaped to receive the at least one lifting system wheel and allowing controlled relative movement of the at least one lifting system wheel in the saw wheel support as the saw blade moves in the plunge direction.

11. The concrete saw of claim 1, wherein the concrete saw is an existing concrete saw and includes the saw frame wherein the platform structure is configured to support the saw frame of the existing concrete saw, the platform structure having rear drive motor and the rear drive motor configured to be powered by the existing concrete saw.

12. The concrete saw of claim 11, wherein the blade height adjustment system includes a lifting system operably joined relative to the saw frame and including at least one lifting system wheel, the blade height adjustment system selectively moving the at least one lifting system wheel relative to the saw frame, the platform structure including a saw wheel support shaped to receive the at least one lifting system wheel and allowing relative rolling movement of the at least one lifting system wheel in the saw wheel support as the blade height adjustment system moves the at least one lifting system wheel relative to the saw frame and the saw blade moves in the plunge direction.

13. The concrete saw of claim 12, wherein the at least one lifting system wheel includes a first lifting system wheel and a second lifting system wheel, the wheel channel includes a first wheel channel shaped to receive the first lifting wheel and a second wheel channel shaped to receive the second lifting wheel.

14. The concrete saw of claim 13, wherein the saw frame has includes rear frame wheel mounts for selectively securing associated rear saw wheels relative to the saw frame, the platform structure including rear platform mounts that are securable relative to the rear frame wheel mounts to further secure the saw frame relative to the platform structure, the rear platform mounts allowing for pivotal movement about the saw pivot axis.

15. The concrete saw of claim 14, wherein the rear frame wheel mounts includes wheel hub mounts and the rear platform mounts being securable to the wheel hub mounts similarly as the associated rear saw wheels after they are removed.

16. The concrete saw of claim 1, wherein the platform structure includes a first platform portion and a second platform portion, the first platform portion including a first rear platform mount and the second platform portion including a second rear platform mount, the saw frame including rear frame wheel mounts for selectively securing associated rear saw wheels relative to the saw frame, the rear frame wheel mounts including a first rear frame wheel mount and a second rear frame wheel mount, the first rear platform mount being selectively securable relative to the first rear frame wheel mount and the second rear platform mount that is selectively securable relative to the second rear frame wheel mount, the first rear platform mount being spaced further from the associated surface corresponding to the platform angle, the first and second rear frame wheel mounts and the first and second rear platform mounts further securing the saw frame relative to the platform structure, the rear platform mounts allowing for pivotal movement about the saw pivot axis.

17. The concrete saw of claim 16, wherein the blade height adjustment system forms a third platform portion of the platform structure, the blade height adjustment system includes a lifting system operably joined relative to the saw frame and includes a first lifting wheel and a second lifting wheel, the second lifting wheel being spaced further from the saw frame than first lifting wheel corresponding to the platform angle, the blade height adjustment system selectively moving the first and second lifting system wheels relative to the saw frame to move the saw blade in the plunge direction at the cut angle.

18. A method of removing a portion of a concrete slab to reduce falling concrete slabs or debris, the method comprising the steps of:
providing a concrete saw according to claim 1 wherein the concrete saw is configured to cut a concrete slab, the concrete saw being able to produce an angled cut wherein the angled cut is at a cut angle that is less than 90 degrees relative to a top slab surface of the concrete slab;
positioning the concrete saw on the concrete slab to be cut.
cutting the concrete slab along a first slab cut line at a first cut angle, the cutting of the first slab cut line forming a first removed side edge of a removed slab portion and separating the first removed side edge from a corresponding first remaining side edge of a remaining slab portion of the concrete slab, the first slab cut line extending inwardly from a first side top extent at the top slab surface to a first side bottom extent, the first cut angle being less than 90 degrees relative to the top slab surface and extending inwardly toward the first bottom extent such that the first side top extent of the first removed side edge extends over top of the first remaining side edge of the remaining slab portion thereby allowing the first remaining side edge of the remaining slab portion to support a first part of a removed slab weight of the removed slab portion;
cutting the concrete slab along a second slab cut line at a second cut angle, the cutting of the second slab cut line forming a second removed side edge of the removed slab portion and separating the second removed side edge from a corresponding second remaining side edge of the remaining slab portion, the second slab cut line extending inwardly from a second side top extent at the top slab surface to a second side bottom extent, the second cut angle being less than 90 degrees relative to the top slab surface and extending inwardly toward the second bottom extent such that the second side top extent of the second removed side edge extends over top of the second remaining side edge of the remaining slab portion thereby allowing the second remaining side edge of the remaining slab portion to support a second part of a removed slab weight of the removed slab portion; and,
supporting the removed slab weight with the first and second remaining side edges of the remaining slab portion to prevent the removed slab portion from falling.

19. The method of claim 18, further including the steps of cutting the concrete slab on at least a third slab cut line to fully separate the removed slab portion from the remaining slab portion.

20. The method of claim 19, wherein the cutting of the at least a third slab cut line is after the cutting of the first and second slab cut lines.

21. The method of claim 18, wherein the first and second part of a removed slab weight is substantially all of the slab weight
